(19) United States
(12) Patent Application Publication
(10) Pub. No.: US 2016/0330303 A1
(43) Pub. Date: Nov. 10, 2016

(54) A PHONE TO ACHIEVE RAPIDLY IMPLEMENTING OFFICE WORK HANDLING AND A METHOD OF USING PHONES TO ACHIEVE FAST OFFICE

(71) Applicant: Demin Liu, Dazhou, Sichuan (CN)

(72) Inventor: Demin Liu, Dazhou, Sichuan (CN)

(21) Appl. No.: 15/107,102

(22) PCT Filed: Nov. 24, 2014
(86) PCT No.: PCT/CN2014/001043

§ 371 Date: Jun. 22, 2016

(30) Foreign Application Priority Data
Dec. 25, 2013 (CN) 201310723973.3

(51) Int. Cl. H04M 1/23; H04M 1/02

(52) U.S. Cl. CPC H04M 1/236; H04M 1/0214; H04M 1/0235; H04M 2250/22

(57) ABSTRACT

This invention relates to a phone to achieve rapidly implementing office work handling. The front of the phone in the present invention contains a large-screen keyboardless structure, wherein the back of the phone is contains two rear keyboard areas, wherein the two keyboard areas contain multiple keys, and relates to a method to use phones to achieve rapidly implementing office work handling, wherein the phone comprises a communication application mode and an office application mode, wherein when the phone is in office application mode, the users' four fingers, except for the thumb of one hand, control the letter keys of a rear keyboard area; wherein the users' four fingers, expect for the thumb of the other hand, control the letter keys of the other rear keyboard area. Further, the left key and stylus can function as a mouse.

### TECHNICAL FIELD

This invention involves a phone as well as a method to use phones for office applications, especially to achieve rapidly implementing office work handling as well as a method for achieving the same.

### BACKGROUND

“Smartphones,” such as iPhones, generally speaking, have both calling and computing functionality. Consequently, phones show great promise to replace traditional computers due to their compact volume, outstanding configuration and excellent performance. However, current phones cannot completely achieve office functions satisfactorily. For example, traditional phones and smartphones do not have a ten-finger keyboard and flexible mouse, like that of a PC, while using office applications, such as Microsoft Word or AutoCad, to edit a large number of texts, or draw graphics. Hence, the current phone configuration can not achieve numerous text editing or drawing functions, which hinders its further development and restricts the application of the phone in the office context.

### SUMMARY OF THE INVENTION

To solve the above-mentioned problems, this invention provides a phone to achieve rapidly implementing office work handling (fast-office) applications and a method of using a phone to achieve the same.

Specifically, this invention achieves the above mentioned objectives through the following technical proposal:

In one aspect of the present invention, a phone for fast-office, comprising a large front screen and a keyboardless structure; the back of the phone is equipped with two rear keyboard areas, each of which include multiple keys.

Additionally, the two rear keyboard areas can achieve ten-finger keyboard functionality, similar to that of a personal computer.

In another aspect of the fast-office phone, the two rear keyboard areas contain 12 letter keys; the frame of the fast-office phone is equipped with multiple frame keys, including two letter keys and partial function keys; the long side of the fast-office phone refers to a left-right direction; the short side of the fast-office phone refers to an up-down direction; the two keyboard areas are situated in a left-right direction or an up-down direction.

Further, in another aspect of the present invention, there are totally 26 letter keys, including 12 keys in the two rear keyboard areas respectively, which are controlled by the fingers, except for the thumbs. The other two frame keys are controlled by the thumbs. This compact arrangement is efficient and does not interfere with the phone's functionality.

In another aspect of the fast-office phone, the front screen of the fast-office phone contains a virtual key area to use punctuation marks, numbers and partial function keys, which are operated by the thumbs.

In another aspect of the fast-office phone, the letter keys in the rear keyboard area comprised of four lines and three rows. In this way, the letter keys of every line can correspond to the other fingers except for the thumbs.

In another aspect of the fast-office phone, the middle line is slightly lower than the other two lines, but the middle line is wider than the other two lines. The letter keys in the middle line are suitable for putting fingers and conducing positioning. The height of the letter keys of the side lines is slightly higher than others for temporary control.

In another aspect of the fast-office phone, the split bar is used to separate the adjacent letter keys; the spilt bar is slightly higher than the middle line among the three letter keys. This structure not only allows for a small and compact keyboard, but enables the fingers to locate the concave keys rapidly, as well as accurately operate three keys in the corresponding lines via minimum displacement, which solves existing sight problems of the rear keyboards.

In another aspect of the fast-office phone, the multiple frame keys also contain a return key, delete key, space key and a left key; the outer edge of the fast-office phone is fitted with a stylus.

In another aspect of the present invention, the mentioned rear keyboard areas is permanently connected with the phone body or the mentioned rear keyboard area is connected to the phone body via folding, sliding, rotating or dismounting forms.

Additionally, a method of implementing a fast-office phone is disclosed, comprising a large front screen and a keyboardless structure; the back of the phone is equipped with two rear keyboard areas, each of which include multiple keys, said method comprises: Configuring the fast-office phone with a communication application mode and office application mode; when the mentioned phone is in office application mode, the users' four fingers, excluding the thumb of one hand control the letter keys of the rear keyboard areas respectively; the users' four fingers excluding the thumb of the other hand control the letter keys of the the rear keyboard areas respectively; the users' two thumbs control the mentioned frame keys respectively.

Another method of implementing a fast-office phone is disclosed, comprising two rear keyboard areas containing 12 letter keys; the frame of the fast-office phone is equipped with multiple frame keys, including two letter keys and partial function keys; the long side of the fast-office phone refers to a left-right direction; the short side of the fast-office phone refers to an up-down direction; the two keyboard areas are situated in a left-right direction or an up-down direction; and wherein the multiple frame keys also contain a return key, delete key, space key and a left key; the outer edge of the fast-office phone is fitted with a stylus, said method comprising configuring the phone with a communication application mode and an office application mode, wherein, the users' four fingers excluding the thumb of one hand control the letter keys of one of the rear keyboard areas when the phone is in office application mode; and, the users' four fingers excluding the thumb of the other hand control the letter keys of the other rear keyboard area; the users' two thumbs control the frame keys respectively; the stylus and left key are used as a mouse, of which the stylus is used as the mouse's pointer, and the left key is used as the mouse's left key; the long-click stylus with selected object can be used as the mouse's right key.

The beneficial effects of this invention are as follows:

This invention allows the letter keys of the two rear keyboard areas to correspond to the fingers, except for the thumbs, by placing two rear keyboard areas at the back of phone. This compact keyboarding arrangement is user-friendly. In this way, the stylus appears to operate like a mouse. And, the phone can operate more like a PC so as to meet one's office demands of editing, storing, and manipulating a large number of texts and pictures.

### BRIEF DESCRIPTION OF FIGURES

FIG. 1 is the front view 1 of the phone mentioned in this invention to achieve fast office;

FIG. 2 is the rear view 1 of the phone mentioned in this invention to achieve fast office;

FIG. 3 is the front view 2 of the phone mentioned in this invention to achieve fast office;

FIG. 4 is the rear view 2 of the phone mentioned in this invention so achieve fast office;

### DETAILED DESCRIPTION

While the making and using of various embodiments of the present invention are discussed in detail below, it should be appreciated that the present invention provides many applicable inventive concepts which can be embodied in a wide variety f specific contexts. The specific embodiments discussed herein are merely illustrative of specific ways to make and use the invention, and do not delimit the scope of the present invention.

### EXAMPLE 1

This example takes the long side of the phone as the left-right direction during use. This application is rather common.

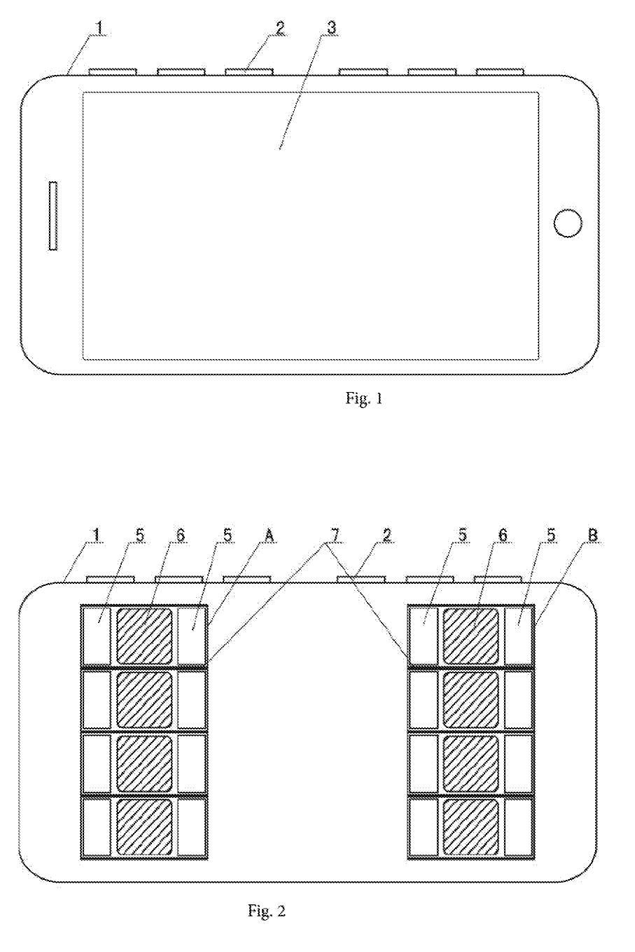

As shown in FIG. 1 and FIG. 2, the front of phone 1 is a large-screen and keyboardless structure. The front screen of phone 1 is set up with a virtual key area (not showed in the figure); the back of phone 1 is set up with two rear keyboard areas. That is, the rear keyboard area A and rear keyboard area B; the long side of phone 1 is used as the left-right direction; and, the short side of phone 1 is used as up-down direction; the rear keyboard areas A and B are positioned in a left-right direction; the rear keyboard areas A and B each contain 12 letter keys respectively, which are in four lines and three rows. The height of the middle line among three letter keys is slightly lower than the other two lines, but the width of the middle line is larger than the other lines; the letter keys of the middle line form rather wide concavo key 6, while the letter keys of the other two lines form rather narrow convex key 5; the split bar 7 is used to separate the adjacent letter keys, whose height is slightly higher than that of concavo key 6; the frame of phone 1 is set up with multiple frame key 2, including two letter keys as well as return key, delete key, space key and left key. The outer edge of phone 1 is equipped with a stylus (not shown in the figure). If the normal functions of phone 1 are not affected, the stylus can be installed to any of the edges without frame key 2 according to its length; as shown in FIG. 2, the rear keyboard areas A and B are permanently connected to phone 1 respectively, or they can be connected with phone 1 via folding, sliding, rotating or dismounting forms.

Additionally, in reference to FIGS. 1 and 2, the phone 1 can achieve fast office by using the following methods: the phone 1 is configured with an communication application mode and an office application mode. When phone 1 is in office application mode, the users' other fingers (except for the thumb) of one hand control the letter keys of the rear keyboard area A; the users' other fingers (except for the thumb) of the other hand control the letter keys of the rear keyboard area B; the users' two thumbs control the frame keys 2 and the virtual key area respectively.

In order to operate more like a PC, the stylus and the left key of frame key 2 are combined as a mouse, of which the stylus is used as the mouse's pointer and the left key is used as the mouse's left key; the long-click stylus with selected object can be used as the mouse's right key;

### EXAMPLE 2

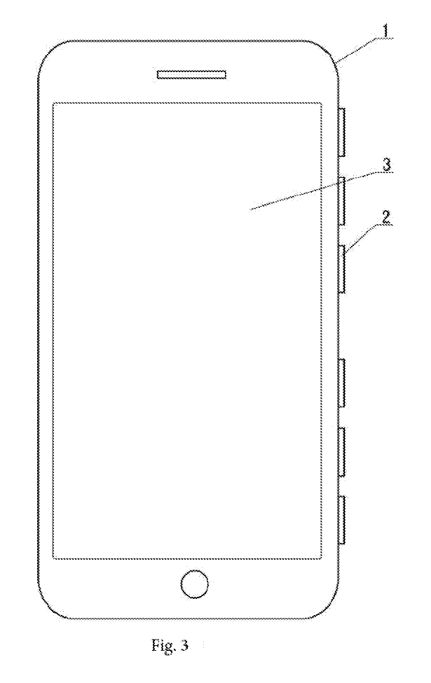

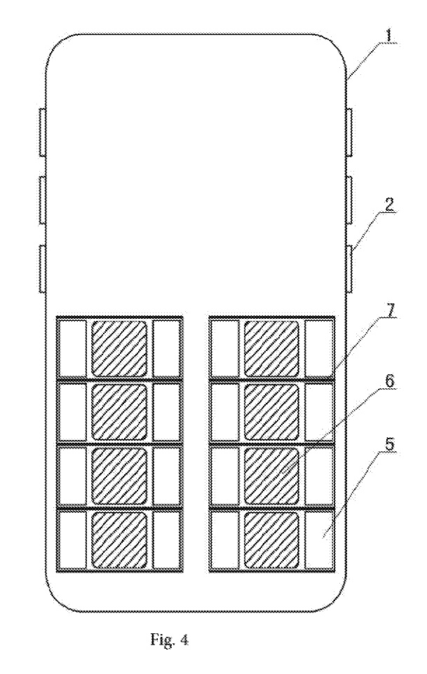

As shown in FIG. 3 and FIG. 4, the difference between this example and example 1 lies in: the short side of phone 1 is situated in the left-right direction while in use, and the rear keyboard areas A and B are ranged 90°integral-rotation. The frame key 2 is set up on two long edges of phone 1; the other structures and usages are the same as the above mentioned example 1.

Obviously, many modifications and variations of the present invention are possible in light of the above teachings. It is therefore to be understood that, within the scope of the appended claims, the invention may be practiced otherwise than as specifically described.

1. A phone for fast-office, comprising a large front screen and a keyboardless structure; wherein the back of the phone is equipped with two rear keyboard areas, wherein each of which include multiple keys.

2. The phone for fast-office of claim 1, comprising two rear keyboard areas containing 12 letter keys; wherein the frame of the fast-office phone is equipped with multiple frame keys, including two letter keys and partial function keys; wherein the long side of the fast-office phone refers to a left-right direction; wherein the short side of the fast-office phone refers to an up-down direction; wherein the two keyboard areas are situated in a left-right direction or an up-down direction.

3. The fast-office phone of claim 2, wherein the front screen of the fast-office phone contains a virtual key area.

4. The fast-office phone of claim 2, wherein the letter keys in the rear keyboard area comprised of four lines and three rows.

5. The fast-office phone of claim 4, wherein the middle line is slightly lower than the other two lines, wherein the middle line is wider than the other two lines;

6. The fast-office phone of claim 5, wherein the split bar is used to separate the adjacent letter keys; wherein the spilt bar is slightly higher than the middle line among the three letter keys.

7. The fast-office phone of claim 2, wherein the multiple frame keys also contain a return key, delete key, space key and a left key; wherein the outer edge of the fast-office phone is fitted with a stylus.

8. According to the fast-office phone mentioned in any item of claim 7, wherein the mentioned rear keyboard areas is permanently connected with the phone body.

9. A method of implementing a fast-office phone comprising a large front screen and a keyboardless structure; the back of the phone is equipped with two rear keyboard areas, each of which include multiple keys, said method comprising:
configuring the fast-office phone with a communication application mode and office application mode; when the mentioned phone is in office application mode, wherein the users' four fingers, excluding the thumb of one hand control the letter keys of the rear keyboard areas respectively; wherein the users' four fingers excluding the thumb of the other hand control the letter keys of the rear keyboard areas respectively; wherein the users' two thumbs control the mentioned frame keys respectively.

10. A method of implementing a fast-office phone, comprising two rear keyboard areas containing 12 letter keys; the frame of the fast-office phone is equipped with multiple frame keys, including two letter keys and partial function keys; the long side of the fast-office phone refers to a left-right direction; the short side of the fast-office phone refers to an up-down direction; the two keyboard areas are situated in a left-right direction or an up-down direction; and wherein the multiple frame keys also contain a return key, delete key, space key and a left key; the outer edge of the fast-office phone is fitted with a stylus, said method comprising:
Configuring the phone with a communication application mode and an office application mode, wherein, the users' four fingers excluding the thumb of one hand control the letter keys of one of the rear keyboard areas when the phone is in office application mode; and, the users' four fingers excluding the thumb of the other hand control the letter keys of the other rear keyboard area; the users' two thumbs control the frame keys respectively; the stylus and left key are used as a mouse, of which the stylus is used as the mouse's pointer, and the left key is used as the mouse's left key; the long-click stylus with selected object can be used as the mouse's right key.

11. According to the fast-office phone mentioned in any item of claim 7, wherein the mentioned rear keyboard area is connected to the phone body via folding, sliding, rotating or dismounting forms.
